(19) United States
(12) Patent Application Publication
(10) Pub. No.: US 2024/0357427 A1
(43) Pub. Date: Oct. 24, 2024

(54) OPERATION EXPANSION POLICY FRAMEWORK FOR ACCESS POINTS

(71) Applicant: QUALCOMM Incorporated, San Diego, CA (US)

(72) Inventors: Alfred ASTERJADHI, San Diego, CA (US); Gyanranjan HAZARIKA, Milpitas, CA (US); Gaurang NAIK, San Diego, CA (US); Abhishek Pramod PATIL, San Diego, CA (US); George CHERIAN, San Diego, CA (US); Sandip HOMCHAUDHURI, San Jose, CA (US); Manish SHUKLA, Milpitas, CA (US); Sai Yiu Duncan HO, San Diego, CA (US); Yanjun SUN, San Diego, CA (US); Abdel Karim AJAMI, San Diego, CA (US)

(21) Appl. No.: 18/303,514

(22) Filed: Apr. 19, 2023

(51) Int. Cl. H04W 28/18

(52) U.S. Cl. CPC H04W 28/18

(57) ABSTRACT

This disclosure provides methods, components, devices and systems for operation expansion policy framework for access points (APs). An example method, performed by a first wireless node, includes outputting, for transmission, information that indicates at least one of (i) one or more criteria that, when met by a second wireless node, indicate the second wireless node is allowed to request that the first wireless node modify one or more wireless operating parameters, or (ii) one or more options for modifying the wireless operating parameters of the first wireless node, obtaining a first request that requests the first wireless node to modify the wireless operating parameters, and processing the first request based on the information.

### TECHNICAL FIELD

This disclosure relates generally to wireless communication, and more specifically, to an operation expansion policy framework for access points (APs).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods and devices of this disclosure each have several innovative aspects, no single one of which is solely responsible for the desirable attributes disclosed herein.

One innovative aspect of the subject matter described in this disclosure may be implemented at an apparatus for wireless communications at a first wireless node. The apparatus includes a processor; memory coupled with the processor; and instructions stored in the memory and executable by the processor to cause the first wireless node to: output, for transmission, information that indicates at least one of (i) one or more criteria that, when met by a second wireless node, indicate the second wireless node is allowed to request that the first wireless node modify one or more wireless operating parameters, or (ii) one or more options for modifying the wireless operating parameters of the first wireless node; obtain a first request that requests the first wireless node to modify the wireless operating parameters; and process the first request based on the information.

Another innovative aspect of the subject matter described in this disclosure may be implemented at an apparatus for wireless communications at a second wireless node. The apparatus includes a processor; memory coupled with the processor; and instructions stored in the memory and executable by the processor to cause the second wireless node to: obtain information that indicates at least one of (i) one or more criteria that, when met by the second wireless node, indicate the second wireless node is allowed to request a first wireless node to modify one or more wireless operating parameters, or (ii) one or more options for modifying the one or more wireless operating parameters of the first wireless node; and output, for transmission, a first request that requests the first wireless node to modify the wireless operating parameters based on the information.

Another innovative aspect of the subject matter described in this disclosure can be implemented as a method for wireless communications performable at a first wireless node. The method may include outputting, for transmission, information that indicates at least one of (i) one or more criteria that, when met by a second wireless node, indicate the second wireless node is allowed to request that the first wireless node modify one or more wireless operating parameters, or (ii) one or more options for modifying the wireless operating parameters of the first wireless node; obtaining a first request that requests the first wireless node to modify the wireless operating parameters; and processing the first request based on the information.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIG. 4 shows a pictorial diagram of another example wireless communication network.

FIG. 5 shows a diagram illustrating various states associated with AP power save.

FIG. 6 shows a call flow diagram illustrating example communication between an AP and a STA, in accordance with certain aspects of the present disclosure.

FIG. 7 shows a call flow diagram illustrating example communication between an AP and a STA where the STA's request is denied, in accordance with certain aspects of the present disclosure.

FIG. 8 shows a call flow diagram illustrating example communication between an AP and a STA where the STA's request is accepted, in accordance with certain aspects of the present disclosure.

FIG. 9 shows a flowchart illustrating an example process performable by a first wireless node configured as an AP.

FIG. 10 shows a flowchart illustrating an example process performable by a second wireless node configured as a STA.

FIG. 11 shows a block diagram of an example wireless communication device.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to wireless communication. Some aspects more specifically relate to techniques for operation expansion policy frameworks for APs.

Power savings (PS) features are increasingly important considerations for wireless network deployments. For example, AP power save (PS) is a feature in ultra-high reliability (UHR) wireless communications. In some cases, an AP, such as an AP multi-link device (MLD), may use one or more tools to save power. For example, an AP may use bandwidth (BW) reduction, number of spatial streams (NSS) reduction, Link disablement via traffic identifier (TID)-to-link mapping (T2LM) or link deletion via multilink (ML) Reconfiguration, among other tools, to achieve power savings.

In some cases, implementing PS modes may present challenges in certain situations, such as when a station (STA) has urgent traffic to transmit. In such cases, certain measures taken by the AP to save power may impact the STA's performance. In such cases, the STA may request that an AP modify operating parameters to expand its operation (e.g., to enable (or alternatively, add) a disabled (or, deleted) link). The STA may or may not have prior knowledge that the AP's current parameters are due to AP PS. In some cases, a STA may request expansion even if it does not have urgent need to transmit. For example, a non-AP STA may also want to conserve its power. Therefore, it may want to flush (send all of) its uplink (UL) traffic as soon as possible, in order to return to a low power state. If the AP is operating at 20 MHz, for example, the non-AP STA may request expansion to 80 MHz, even if the UL traffic is not urgent.

Aspects of the present disclosure provide a framework that enables a wireless node (e.g., a non-AP STA) to flexibly request operational changes (such as expansion). This framework may provide certain criteria that, if met, allows a STA to send a request to modify operating parameters. The framework may allow an AP/non-AP STA to save power in the presence of other clients/STAs (e.g., clients that are greedy with respect to wireless resources), but also allows clients to deliver urgent traffic so that their performance is not impacted.

Aspects of the present disclosure provide techniques that may allow an AP (e.g., or AP MLD) to define a policy (e.g., a power save (PS) policy). In some aspects, this policy may be announced/broadcasted by the AP (e.g., via Beacons/Probe Response or during Association). In some aspects, the AP may send the policy information only when a STA (e.g., non-AP STA or non-AP MLD) asks for AP's policy or when STA requests an expansion of operation. According to certain aspects, the policy may include expansion options, criteria to request expansion, penalties for violating criteria, duration of expansion, and/or any additional conditions. In some aspects, an AP and a STA may use Request and Response frames to agree on (e.g., negotiate) operation expansion. In some aspects, in response to a request, an AP may accept, decline or suggest an alternative (e.g., negotiate).

Utilization of the techniques disclosed herein may provide significant advantages, enabling an AP to define and/or broadcast a policy to help optimize power savings in the presence of greedy or malicious clients, while also allowing genuine/compliant clients to request and/or negotiate operation expansion in order to deliver urgent traffic so that their performance is not impacted.

### Example Wireless Communication Network

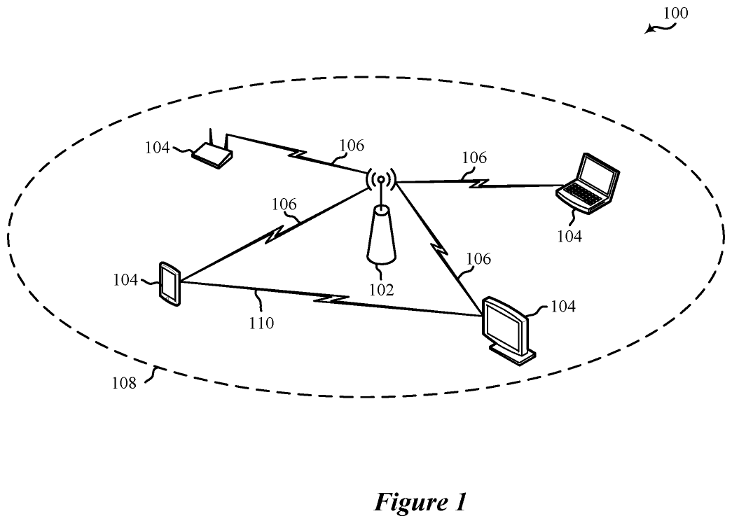

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.1 lax, 802.11az, 802.11ba, 802.11bd, 802.11be, 802.11bf, and the 802.11 amendment associated with Wi-Fi 8). The WLAN 100 may include numerous wireless communication devices such as a wireless access point (AP) 102 and multiple wireless stations (STAs) 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IOT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcastbeacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (ps)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.1 lac, 802.1 lax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

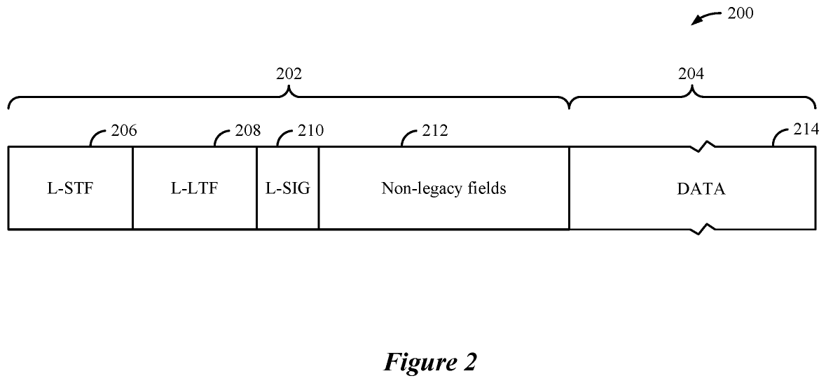

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

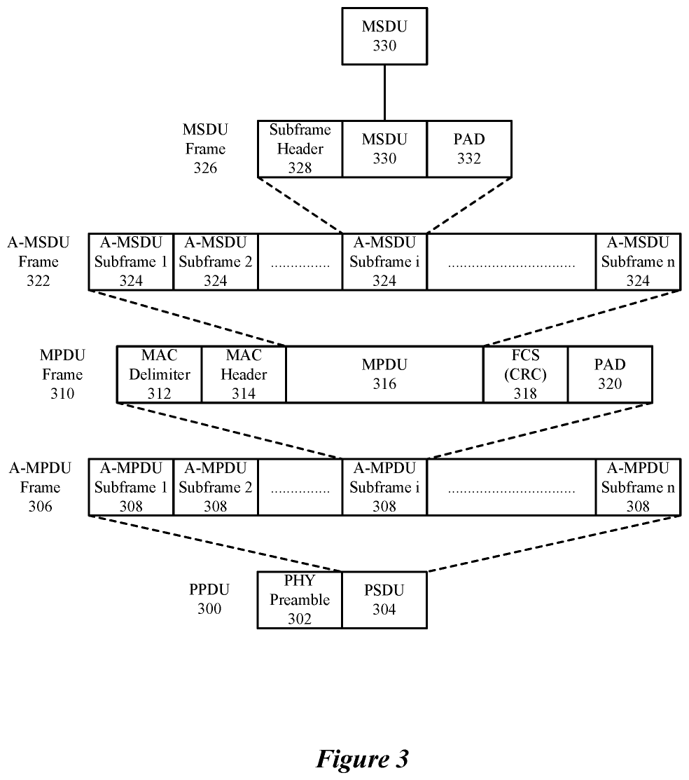

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs) 316. For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

Some APs and STAs may implement techniques for spatial reuse that involve participation in a coordinated communication scheme. According to such techniques, an AP may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP, The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some other examples of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units (RUs) associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or EDCA techniques. Additionally, by enabling a group of APs associated with different BSSs to participate in a coordinated AP transmission session, during which the group of APs may share at least a portion of a single TXOP obtained by any one of the participating APs, such techniques may increase throughput across the BSSs associated with the participating APs and may also achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, an RX power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

Retransmission protocols, such as hybrid automatic repeat request (HARQ), also may offer performance gains. A HARQ protocol may support various HARQ signaling between transmitting and receiving wireless communication devices as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, If a receiving device cannot properly decode (and cannot correct the errors) a first HARQ transmission received from the transmitting device, the receiving device may transmit a HARQ feedback message to the transmitting device (for example, a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an ARQ protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

Some wireless communication devices (including both APs and STAs) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

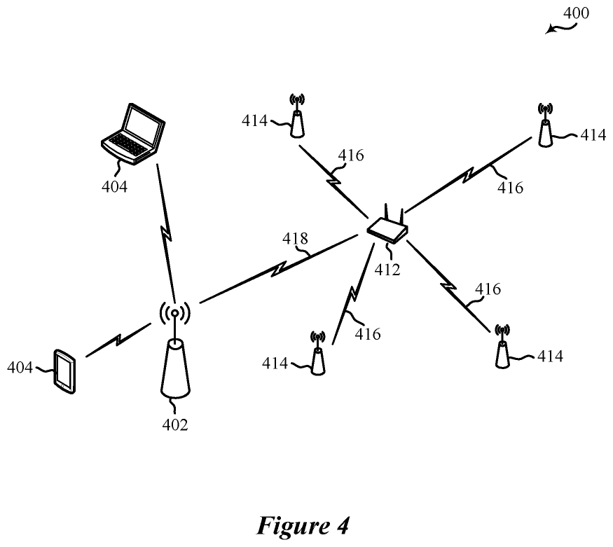

FIG. 4 shows a pictorial diagram of another example wireless communication network 400. According to some aspects, the wireless communication network 400 can be an example of a mesh network, an IOT network or a sensor network in accordance with one or more of the IEEE 802.11 family of wireless communication protocol standards (including the 802.11ah amendment). The wireless network 400 may include multiple wireless communication devices 414. The wireless communication devices 414 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 414 sense, measure, collect or otherwise obtain and process data and then transmit such raw or processed data to an intermediate device 412 for subsequent processing or distribution. Additionally or alternatively, the intermediate device 412 may transmit control information, digital content (for example, audio or video data), configuration information or other instructions to the wireless communication devices 414. The intermediate device 412 and the wireless communication devices 414 can communicate with one another via wireless communication links 416. In some examples, the wireless communication links 416 include Bluetooth links or other PAN or short-range communication links.

In some examples, the intermediate device 412 also may be configured for wireless communication with other networks such as with a Wi-Fi WLAN or a wireless (for example, cellular) wide area network (WWAN), which may, in turn, provide access to external networks including the Internet. For example, the intermediate device 412 may associate and communicate, over a Wi-Fi link 418, with an AP 402 of a WLAN network, which also may serve various STAs 404. In some examples, the intermediate device 412 is an example of a network gateway, for example, an IOT gateway. In such a manner, the intermediate device 412 may serve as an edge network bridge providing a Wi-Fi core backhaul for the IOT network including the wireless communication devices 414. In some examples, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IOT network and the data it transports.

### Example AP Power Save (PS)

As noted above, AP Power Save (PS) mechanisms may be a key feature in current and upcoming wireless networks, but PS mechanisms may come at the cost of performance of associated STAs. Aspects of the present disclosure, however, provide a flexible framework that provides a balance, for example, between a AP objective of power saving and STAs performance objective.

In some cases, APs may be expected to generally be in an Active mode, operating at maximum BW and NSS so that associated STAs can get the highest throughput and fastest service possible. In such cases, AP power consumption may not be considered or weighted as an issue (e.g., because the APs may be wall powered). However, the amount of power consumed by APs is significant and this energy needs to be generated somewhere which increases maintenance costs of the network, battery life of the device hosting the network (e.g., if battery operated), ecological footprint of the wireless network. These power considerations may be even more important for multi-link and multi-AP networks, since power consumption increases linearly with number of links and APs in same network. Because of this, various types of AP power save (PS) mechanisms may be deployed.

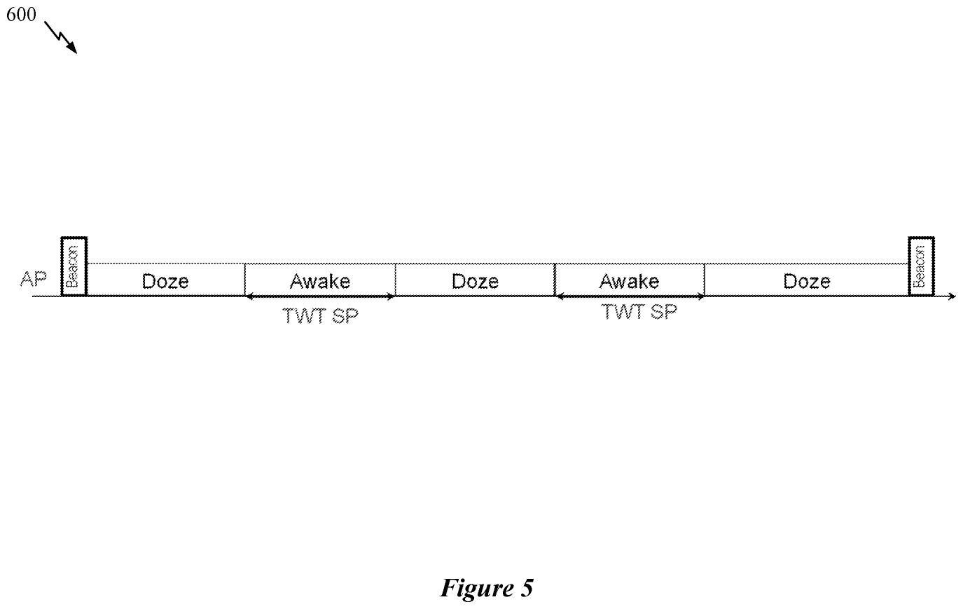

FIG. 5 shows a diagram illustrating various states associated with one example of a target wakeup time (TWT) based AP power save (PS) framework. In such deployments, STAs may negotiate individual or broadcast TWT agreements with the AP. For example, an AP may set a Responder power management (PM) bit to 1 if the AP intends to go to doze state outside of TWT service periods (SPs). In some cases, the Responder PM bit may be set to 1 only if all associated STAs support TWT and TWT Required in an information element (IE) (e.g., an HE Operation IE) is 1. Generally, STAs should not transmit outside of their TWT SPs (e.g., as there may be nobody to receive).

As illustrated in FIG. 5, an AP may transition to a doze state 504 outside of negotiated TWT SPs. The AP may still send Beacons 502 every target beacon transmission time (TBTT). In some cases, when an AP transitions from doze state to awake state 506 on a channel, it may be considered “blind” to the channel. Blindness may generally refer to a situation in which there may be an ongoing transmission on the channel whose preamble the AP missed (e.g., due to the doze state). Therefore, the AP may not be aware of (e.g., or may not have recorded) its duration. In some cases, the AP may perform energy detection to sense if there is an ongoing transmission. However, energy detection may not be sufficient, since the energy detection threshold may be 20 dB higher than the preamble detection threshold, according to certain wireless communications standards (e.g., 802.11). Certain wireless communications standards (e.g., 802.11be) may include certain rules to facilitate recovery from blindness. In some cases, for example, if a blind STA receives a frame from another STA, it may be able to achieve synchronization with the channel.

Some STAs may have additional AP power save functionalities/features. For example, in some cases, an AP may explicitly indicate during which Beacon Intervals (BI) it may go to a doze state outside of SPs (e.g., by setting the PM bit to 1 in the Beacon frame that corresponds to that BI). The SPs may be the negotiated TWT SPs or restricted access windows (RAWs). In some cases, a STA may specify to the AP a maximum away duration that the AP is allowed to go to sleep. This may be useful in cases when a STA has latency sensitive traffic.

In some cases, an AP can be temporarily disabled (e.g., link disablement) under an AP MLD framework. STAs on the disabled links may either move to another BSS (e.g., if single-link) or simply suspend their operation (e.g., if multi-link). In some cases, after disabling one or more links, at least one link may be kept on to serve all associated STAs. Disabling one or more links of an AP MILD may cause long term changes that may impact all STAs operating in the disabled link. Additionally, disabling one or more links of an AP MLD may impact enabled links, since the load of the BSS on the enabled link may increase.

Some AP PS mechanisms that may be utilized include static AP PS (e.g., TWT-based ON-OFF duty cycling of an AP) on a link. This may impact all STAs operating on the link. Other AP PS mechanisms may be used, such as dynamic AP PS on a link, which may have a minimal (e.g., and/or short term) impact on STAs operating on that link. In some cases, AP PS mechanisms may include reduction of bandwidth (BW) or reduction of a number of spatial streams (NSS).

In some cases, an AP MLD may use one or a combination of the mechanisms described above in order to maximize power savings while minimizing negative impacts to key performance indicators of associated STAs.

### Example Operation Expansion Policy Framework

As noted above, implementing PS modes may present challenges in certain situations, such as when a station (STA) has urgent traffic to transmit. In such cases, certain measures taken by the AP to save power may impact the STA's performance. In such cases, the STA may request that an AP expand operating parameters. The STA may or may not have prior knowledge that the AP's current parameters are due to AP PS. In some cases, a STA may request expansion even if it does not have urgent need to transmit. For example, a non-AP STA may also want to conserve its power. In such cases, a STA may want to flush its UL traffic as soon as possible, in order to return to a low power state. If the AP is operating at 20 MHz, for example, the non-AP STA may request expansion to 80 MHz, even if the UL traffic is not urgent.

Aspects of the present disclosure provide a framework that enables a wireless node to flexibly request operational changes (such as expansion). As used herein the term wireless node may refer to an AP, a non-AP STA, an MLD, or a non-MLD. In some cases, techniques described as being performed by or at an AP or a STA may be performed by a wireless node.

This framework may provide certain criteria that, if met, allows a wireless node, such as a STA, to send a request (e.g., an AP STA) to modify operating parameters. The framework may allow an AP/non-AP STA to save power in the presence of other STAs (e.g., that may be greedy with respect to wireless resources), but also allows STAs to deliver urgent traffic so that their performance is not impacted.

Aspects of the present disclosure provide techniques that may allow an AP (e.g., or AP MLD) to define a policy (e.g., a PS policy).

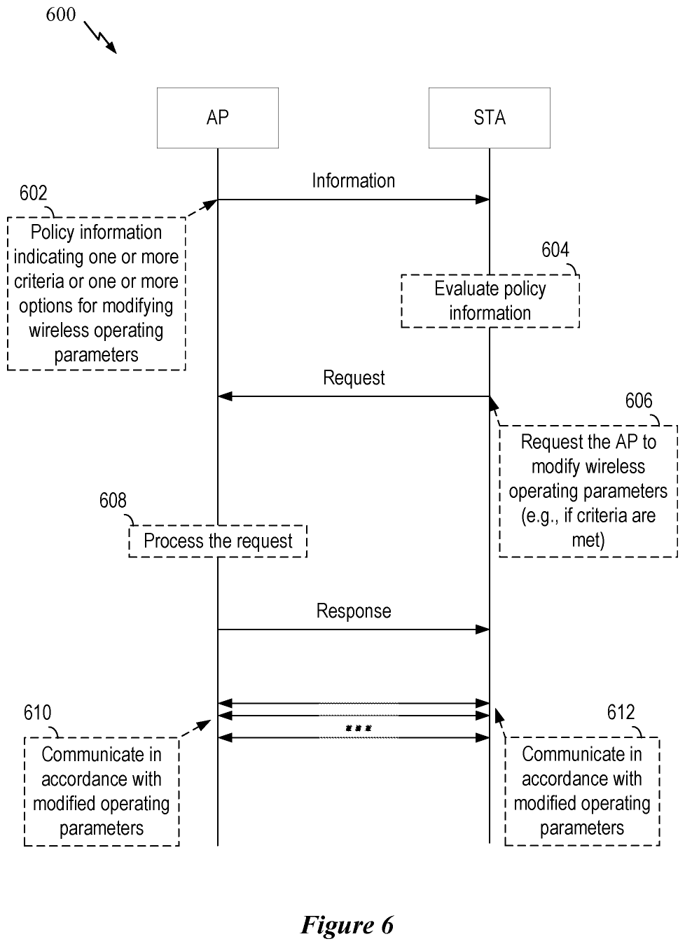

FIG. 6 shows a call flow diagram illustrating example communications between an AP and a STA, in accordance with certain aspects of the present disclosure. Operation of the AP policy framework proposed herein may be understood with reference to the call flow diagram 600 of FIG. 6.

As illustrated at 602, an AP may transmit policy information indicating at least one of: one or more criteria or one or more options for modifying wireless operating parameters.

In some aspects, this policy may be announced/broadcasted by the AP (e.g., via Beacons/Probe Response or during Association). In some aspects, the AP may send the policy information only when a STA (e.g., non-AP STA or non-AP MLD) asks for AP's policy or when STA requests an expansion of operation. According to certain aspects, the policy may include expansion options, criteria to request expansion, penalties for violating criteria, duration of expansion, and/or any additional conditions. In some aspects, an AP and a STA may use Request and Response frames to agree on (e.g., negotiate) operation expansion. In some aspects, in response to a request, an AP may accept, decline or suggest an alternative (e.g., negotiate).

As illustrated at 604, the STA may evaluate the criteria and/or the one or more options. For example, the STA may determine whether it meets the criteria indicated in the policy information.

In some aspects, for example, the one or more criteria may depend on an amount of traffic that the STA has to send or has sent, a type of traffic that the STA has or has sent, a type of the STA, a capability of the STA, a battery state of the STA, and/or a number of requests that the STA has sent in a period of time.

As illustrated at 606, the STA may transmit a request to the AP to modify one or more wireless operating parameters (e.g., in accordance with the one or more options).

As illustrated at 608, the AP may process the request and transmit a response to the STA. As will be described in further detail below, processing the request may include performing one or more actions based on whether the criteria are met, and the response may accept or reject the request accordingly, and may include additional information.

As illustrated at 610 and 612, the AP and STA may communicate in accordance with the modified operating parameters. For example, in a case of expanded operation, bandwidth, a number of links, and/or a number of spatial streams may be increased.

In some cases, the STA may transmit the request only if the criteria are met. In other cases, the STA may transmit the request even if the criteria are not met. As will be described in greater detail below, in some cases, a STA may be penalized for sending a request without meeting the criteria and/or may be rewarded for sending a request when meeting the criteria.

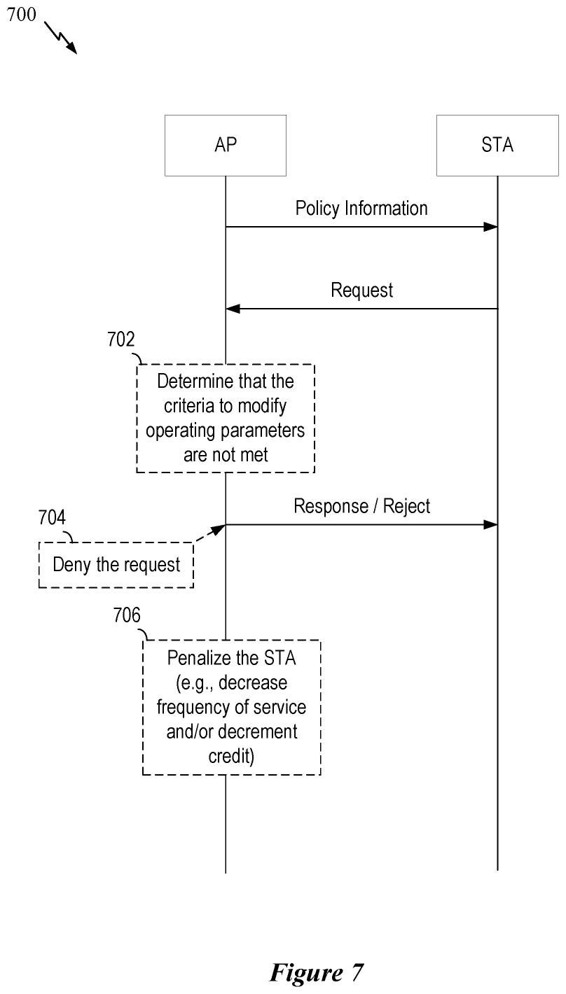

FIG. 7 shows a call flow diagram illustrating example communications between an AP and a STA, where a STA's request to modify wireless operating parameters is denied, in accordance with certain aspects of the present disclosure.

As noted above with reference to FIG. 6, the AP may transmit policy information to the STA, and the STA may transmit a request to the AP.

As illustrated at 702, the AP may determine that the criteria to modify operating parameters are not met. Accordingly, as illustrated at 704, the AP may transmit a response to deny/reject the request.

As noted above, in some aspects, the AP may perform one or more additional actions based on whether the criteria are met. In the example illustrated in FIG. 7, the criteria are not met. Accordingly, as illustrated at 706, the AP may penalize the STA. For example, the AP may decrease a frequency of service and/or decrement credit which may impact how the STA is serviced.

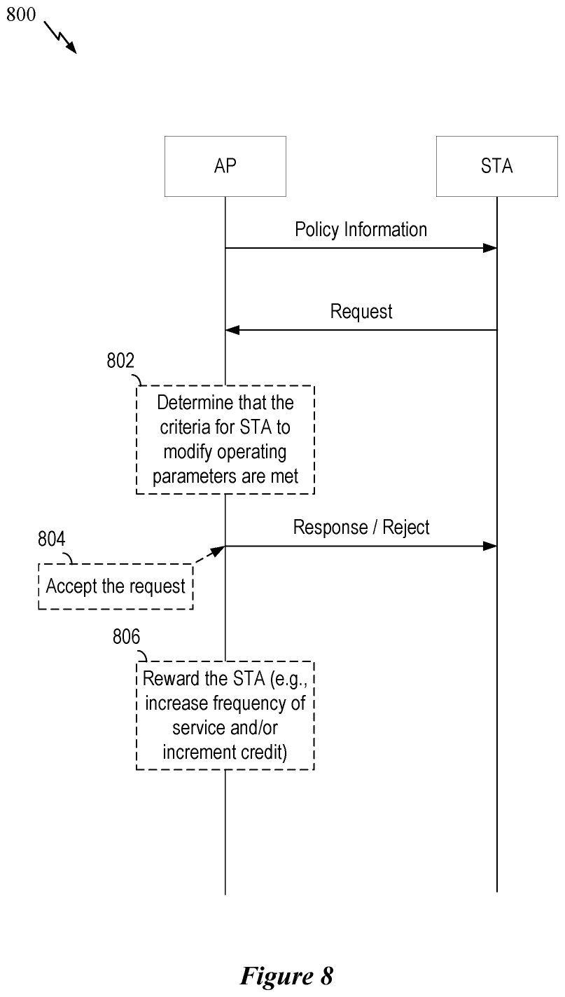

FIG. 8 shows a call flow diagram illustrating example communications between an AP and a STA where STA's request to modify wireless operating parameters is accepted, in accordance with certain aspects of the present disclosure.

As noted above with reference to FIG. 6, the AP may transmit policy information to the STA, and the STA may transmit a request to the AP.

As illustrated at 802, the AP may determine that the criteria to modify operating parameters are met. Accordingly, as illustrated at 804, the AP may transmit a response to accept/grant the request. As noted above, in some aspects, the AP may perform one or more additional actions based on whether the criteria are met. In the example illustrated in FIG. 8, the criteria are met. Accordingly, as illustrated at 806, the AP may reward the STA. For example, the AP may increase a frequency with which it services the STA and/or may increment credit.

According to certain aspects, the policy may include expansion options, criteria to request expansion, penalties for violating criteria, duration of expansion, and/or any additional conditions.

In some cases, an AP and a STA may use Request and Response frames to agree on (e.g., negotiate) operation expansion. In response to a request, an AP may accept, decline or suggest an alternative (e.g., negotiate).

According to certain aspects, expansion options may include what steps the AP can take in response to a non-AP's request to expand operations. As noted above, some examples of expansion options include increasing BW, increasing NSS, enabling an additional (e.g., a disabled) link, enabling an additional (e.g., primary) channel, adding a deleted link, adding a new link, increasing transmit power (e.g., to increase range or signal to interference and noise ratio (SINR)), reducing BW or reducing resource unit (RU) size (e.g., to increase power spectral density (PSD) and SINR), and/or transitioning to predefined modes (e.g., Active mode, PS mode Awake state, enhanced multi-link single radio mode, etc.).

In some cases, wireless communications standards may allow multiple primary channels. In such cases, as noted above, an expansion option may be to increase a quantity of primary channels (e.g., enable an additional primary channel).

According to certain aspects, criteria to request expansion may include conditions under which a non-AP STA is allowed to request expansion.

In some cases, such conditions may depend on an amount or type of traffic a STA has to send or has sent. For example, a non-AP STA may request expansion (e.g., any of the expansion options described above) if it has more than a threshold amount (e.g., more than X bits, where X may be specified by the AP) of traffic, has low-latency traffic, or has high-reliability traffic.

In some cases, one or more conditions may be met if a STA has lower than Y % battery, if the client is a differentiated user (e.g., it has paid access), or if the client has sufficient credits, if the client has a certain type or capability (e.g., a mixed reality (XR) device can request BW expansion, but an Internet of things (IOT) device cannot request any expansion), and/or if the client has requested no more that “z” expansions in the past timeout interval. Example of how credits may be managed are described in further detail below with reference to penalties for violating criteria.

In some cases, the various conditions/criteria (e.g., and thresholds associated with the conditions/criteria) may be configured (e.g., and/or negotiated between an AP and non-AP STA). In some cases, policy information may be updated and an AP may advertise updated policy information. For example, network conditions may change that warrant an update to one or more criteria or one or more options for modifying wireless parameters.

According to certain aspects, different expansion options may be associated with different criteria. In such cases, there may be a mapping between one or more expansion options and one or more criteria for requesting expansion. For example, in some aspects, a non-AP STA may need to meet the criteria of having low-latency traffic in order to request enabling of a disabled link but may need to meet a different criteria (e.g., having more than X bytes of UL traffic) in order to request increased BW or increased NSS.

According to certain aspects, penalties for violating criteria (e.g., sending a request when the criteria are not met) may include punitive actions that the AP may impose on the client. For example, if the AP has a criteria of X Mb of traffic for BW expansion and the client requests BW expansion when it has <X Mb, the STA has violated AP's criteria for expansion and therefore, the AP may impose a penalty. The AP may detect whether the criteria are met in this case by monitoring the amount of traffic from the STA (e.g., in a given period of time).

There are various potential penalties for violating the criteria. For example, a penalty may involve decrementing or decreasing one or more credit points associated with a STA (e.g., STAs may start with a fixed credit), and if credit points reach 0 (e.g., or a configured threshold) the AP may impose a more severe penalty. As an alternative, or in addition, a penalty may involve one or more of: rejecting future requests from the STA/client that violated the criteria (e.g., until a configured time duration or timeout expires, where the time duration/timeout may be infinity), reducing frequency of servicing the client (e.g., sending triggers) until a time duration expires (e.g., time duration may be infinity), or disassociating the STA/client that violated the criteria.

In some aspects, the AP may successively increase the penalty (or increase the penalty time duration) upon each violation.

As noted above, an AP may reward a STA for compliance with the policy (e.g., if the STA meets criteria for expansion). For example, the AP may increment or increase the credit points associated with a STA if a client meets the criteria for expansion. In some aspects, as noted above, the AP may increase a frequency of servicing a client until a time duration expires (e.g., time duration may be infinity).

Additional conditions/criteria may be announced/broadcast by the AP (e.g., as part of the policy, a response, or other signaling). For example, in some aspects, the AP may announce whether a request (e.g., for expansion of operations) should be sent via a management frame or subfield(s) in a data and/or control frame. In some cases, such an announcement may be based on the AP's capability to act on the request. For example, if the AP can perform actions accordingly and/or respond to the request within a time duration (e.g., short interframe spacing (SIFS)), the AP may allow a request via subfield(s) in Data/Control frame (e.g., the Aggregate Control subfield). However, if the AP cannot perform actions accordingly and/or respond to the request within a time duration (e.g., if the AP needs more time), the AP may require the (e.g., non-AP) STA to transmit a request in a management frame (e.g., an Action frame). In some aspects, the conditions may be the same for all expansion options or different for different expansion options. In some aspects, an AP may impose a penalty on the non-AP STA if the non-AP STA does not send the request as per the additional information/criteria advertised by the AP.

In some aspects, the AP may announce (e.g., as part of the policy, a response, or other signaling) whether the STA is to protect the request frame and the type of protection required (e.g., via message integrity check (MIC) or encryption). In some aspects, the AP may announce (e.g., as part of the policy, a response, or other signaling) whether the STA is to transmit the request frame as individually addressed or group addressed.

In some aspects, the AP may announce (e.g., as part of the policy, a response, or other signaling) a duration of expansion of operations. The duration may indicate how long a requested (e.g., and/or accepted/granted) expansion may be valid. In some cases, for example, the duration may be defined based on a current transmission opportunity (TXOP), in which case the expansion ends when the current TXOP ends. In some cases, the duration may be defined as a specific Beacon Interval, wherein the expansion applies during the specified Beacon Interval. The specific Beacon Interval may be the current Beacon Interval, the next Beacon Interval or a Beacon Interval that the AP explicitly specifies. In some cases, the expansion may start and end at specific timing synchronization function (TSF) values, wherein the specific TSF values may be specified by the AP. In some cases, the duration may be specified in the response frame or based on a certain triggering event (e.g., the expansion may be valid until the AP sends a frame with certain configurations (e.g., More Data=0, end of service period (EOSP)=1, and/or power management (PM)=1)). In some cases, the duration may be advertised by the AP in a Management frame (e.g., a probe response frame or a beacon frame).

In some aspects, a duration of expansion may be periodic. For example, periodic expansions may be configured similarly to a target wakeup time (TWT). For example, there may be an expanded Service Period every X milliseconds and/or the expansion duration may be Y milliseconds. In some cases, this may be a variant/type of a TWT. In some aspects, a duration of expansion may be requested by the STA in the request frame or may be negotiated via multiple request frames and response frames.

According to certain aspects, request and response signaling may be sent via Management frames (e.g., Action frames) or through some subfield in a Control or Data frame (e.g., an A-Control field). In some cases, if frames (e.g., in which request and response signaling are sent) are not protected, an attacker may cause the AP to wake up frequently, thereby disrupting the PS of the AP.

According to certain aspects, some or all of the request and/or response frames/signaling/subfields may be protected. In some cases, such protection may be encouraged or required by the policy or other signaling. A non-AP STA may then protect the request, as indicated. In some cases, the AP may impose punitive actions on the non-AP STA if the non-AP STA does not protect the request (e.g., imposing penalties as described above). In some aspects, the protection may be achieved via a Message Integrity Check (MIC). In this case, all STAs in the basic service set (BSS) may become aware of AP's impending expansion. In some aspects, the protection may be achieved via encryption. For example, one or more frames/subfields may be encrypted with an individual key, which may prevent certain attacks (e.g., replay attacks) from illegitimate or malicious users. In some aspects, a frame/signal/subfield may be encrypted with a group key. Otherwise, a rogue, illegitimate, or malicious device may spoof the AP's media access control (MAC) address and advertise an incorrect usage of parameters.

According to certain aspects, additional information may be provided by the AP (e.g., as part of the policy, response, or other signaling). For example, in some cases, an AP may provide additional information including an instruction to a STA to transmit a frame so that the AP or another STA may recover from blindness. A non-AP STA may then transmit the frame, as instructed. In some cases, the AP may impose punitive actions on the non-AP STA if the non-AP STA does not transmit the frame (e.g., imposing penalties as described above).As noted above, blindness generally refers to a situation in which there may be an ongoing transmission on the channel whose preamble is not detected by the AP (e.g., due to the doze state). Transmission of a frame (prompted via a response) may allow a blind node (AP or non-AP STA) to achieve synchronization with the channel.

In some aspects, operation (e.g., operational parameter) expansion or contraction may be a UHR or wireless fidelity (WiFi) framework (e.g., 11bn) and may not be tied to AP power save (PS) operation.

In some aspects, an AP may announce (e.g., unprompted or prompted by a request), why it is operating with certain (e.g., operational) parameters. For example, if a link is disabled, the AP may announce that it is disabling or has disabled the link due to PS reasons.

In some aspects, in response to an expansion request, an AP may provide additional information in the response frame. In some cases, the additional information may indicate a reason for denying an expansion request. For example, if an AP is operating at 40 MHz BW but is capable of 80 MHz operation, the AP may deny the request to expand to 80 MHz and tell the client in the response that a reason for denying the STA's request is for PS reasons or other reasons (e.g., regulatory), that it is denying the request because STA has violated a criteria, and/or that it will accept another request after a certain time duration or timeout interval.

In some cases, as noted above, an AP may provide additional information in a response to a request, including an instruction to a STA to transmit a frame so that the AP or another STA may recover from blindness. In some cases, an AP may provide additional information in a response to a request, including an update to the policy information (e.g., including updates to one or more of expansion options, criteria to request expansion, penalties for violating criteria, duration of expansion, and/or any additional conditions/considerations described herein).

In some aspects, the AP may not be allowed to completely deny a STA's request. For example, in some cases, if the STA has requested enabling a new link, the AP may be required to enable the link. In such cases, however, the AP may choose to operate in the lowest power consumption state (e.g., PS mode with awake state), which may be a limited mode of operation that supports low BW and low NSS, among other parameters. In some cases, for example, such a requirement may be required by wireless communications standards, and/or the AP may announce such a requirement as part of its policy.

According to certain aspects, expansion (e.g., or contraction) of operation or parameters, based on a request from one STA may be applicable/applied to other STAs. For example, in some aspects, a STA may receive (detect) a Request/Response frame sent by/to another non-AP STA. In such aspects, an AP may send the Response frame to a broadcast address so that all (or a plurality of) STAs become aware of the expansion. In some cases, the Response frame may carry an indication to which set of STA(s) the expansion applies. For example, in some aspects, the Response frame may also include an association identifier (AID) bitmap or similar indication that specifies the associated STA(s)/client(s) to whom the expansion applies. In some aspects, the Response frame may also include an explicit indication or an implicit indication that expansion applies to all (or a plurality of) STAs/clients. In some aspects, the Response frame may also include an indication that expansion applies only to STAs that support a certain capability (e.g., support 320 MHz BW) or certain generation of STAs (e.g., very high throughput (VHT) or later generation).

According to certain aspects, each expansion may be a service provided by the AP that has an identifier. For example, in some aspects, an expansion may apply only to the requesting STA by default, but other STAs may send a request to subscribe to that expansion by requesting the identifier associated with the service/expansion.

In some aspects, if a STA that did not send the expansion request receives an expansion response, and if the expansion applies to it, the STA might also expand its operation to match that of the AP (e.g., in order to flush its UL packets faster). Doing so may avoid frame exchange(s) between the receiving STA and the AP.

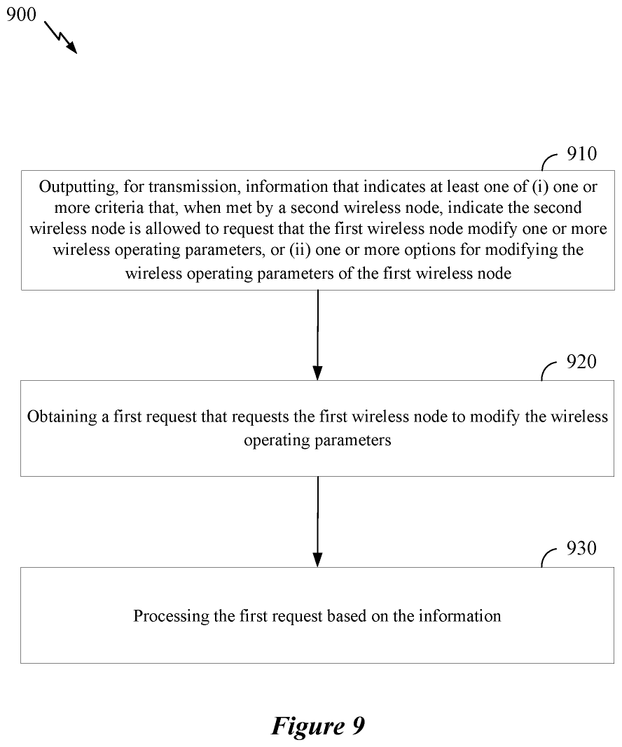

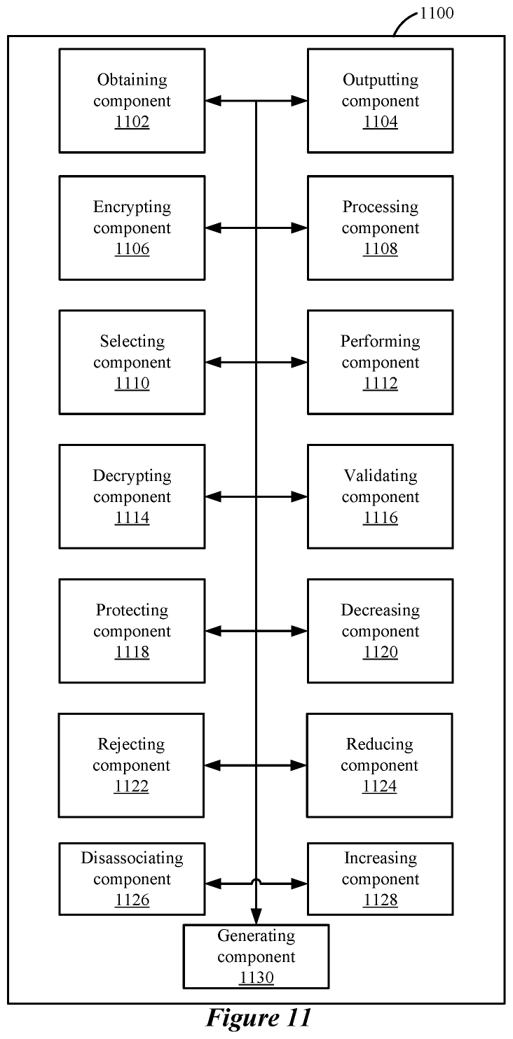

FIG. 9 shows a flowchart illustrating a process 900 performable at a first wireless node, according to some aspects of the present disclosure. The operations of the process 900 may be implemented by the first wireless node or its components as described herein. For example, the process 900 may be performed by a wireless communication device, such as a wireless communication device 1100 described with reference to FIG. 11, operating as or within the first wireless node. In some examples, the process 900 may be performed by the first wireless node, such as one of the wireless APs 102 described with reference to FIG. 1. The operations of the process 900 and subject matter of the present disclosure may be applicable for different systems. For example, the operations of the process 900 and the subject matter of the present disclosure may apply to 802.11s mesh system (as defined in Institute of Electrical and Electronics Engineers (IEEE) 802.11), an easy mesh system (as defined in WiFi Alliance), and/or other mesh-based network systems.

At 910, the process 900 includes the first wireless node outputting, for transmission, information that indicates at least one of (i) one or more criteria that, when met by a second wireless node, indicate the second wireless node is allowed to request that the first wireless node modify one or more wireless operating parameters, or (ii) one or more options for modifying the wireless operating parameters of the first wireless node.

At 920, the process 900 includes the first wireless node obtaining a first request that requests the first wireless node to modify the wireless operating parameters.

At 930, the process 900 includes the first wireless node processing the first request based on the information.

In some aspects, the method 900 further includes outputting, for transmission, additional information that indicates an update to at least one of: the criteria or the options.

In some aspects, the operating parameters comprise at least one of: bandwidth, a number of spatial streams, transmit power, or a resource unit (RU) size.

In some aspects, the options include one or more options to increase or decrease a quantity of active primary channels or a quantity of active links.

In some aspects, at least one of wireless operating parameters is associated with an operating mode.

In some aspects, at least one of the one or more criteria depend on at least one of: an amount of traffic that the second wireless node has to send or has sent, a type of traffic that the second wireless node has to send or has sent, a type of the second wireless node, a capability of the second wireless node, a battery state of the second wireless node, or a number of requests that the second wireless node has sent in a period of time.

In some aspects, the criteria include different criteria corresponding to different options for modifying the wireless operating parameters.

In some aspects, processing the request comprises: performing one or more actions if the second wireless node does not meet at least one of the criteria.

In some aspects, the one or more actions comprise at least one of: decreasing an amount of credit assigned to the second wireless node; rejecting one or more requests from the second wireless node for a period of time; reducing how often the second wireless node is served by the first wireless node for a period of time; or disassociating the second wireless node from the first wireless node.

In some aspects, the method 900 further includes selecting the one or more actions based on a previous action.

In some aspects, the method 900 further includes performing one or more actions if the second wireless node meets at least one of the criteria.

In some aspects, the one or more actions comprise at least one of: increasing an amount of credit assigned to the second wireless node; or increasing how often the second wireless node is served by the first wireless node.

In some aspects, the information further indicates at least one of: a type of a frame to use for signaling the first request for the first wireless node to modify the wireless operating capability, whether the frame should be protected, a type of protection for the frame, or whether the frame should be individually addressed or group addressed.

In some aspects, a modification of the wireless operating capability indicated in the first request will be valid for at least one duration; and the at least one duration is at least one of: indicated in the information, indicated in the first request, negotiated with the second wireless node, or periodic.

In some aspects, the method 900 further includes at least one of: decrypting the first request.

In some aspects, the method 900 further includes validating the first request based on a message integrity check (MIC).

In some aspects, the method 900 further includes outputting, for transmission, a response to the first request.

In some aspects, the method 900 further includes encrypting content of the response to the first request.

In some aspects, the method 900 further includes or protecting the content of the response to the first request via a MIC.

In some aspects, the method 900 further includes outputting, for transmission, a response to the first request, wherein the response indicates at least one of: whether the first request is granted or denied, a reason if the first request is denied, or additional information not previously indicated in the information.

In some aspects, the additional information indicates at least one of: one or more wireless nodes to which the modification indicated in the first request applies, or one or more actions for the second wireless node to perform.

In one aspect, method 900, or any aspect related to it, may be performed by an apparatus, such as wireless communication device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

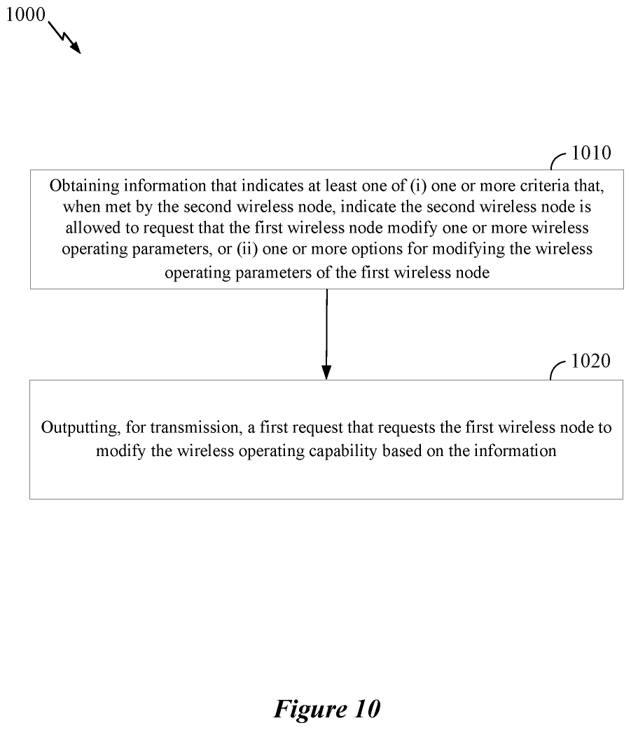

FIG. 10 shows a flowchart illustrating a process 1000 performable at a first wireless node, according to some aspects of the present disclosure. The operations of the process 1000 may be implemented by the first wireless node or its components as described herein. For example, the process 1000 may be performed by a wireless communication device, such as a wireless communication device 1100 described with reference to FIG. 11, operating as or within the first wireless node. In some examples, the process 1000 may be performed by the first wireless node, such as one of the wireless APs 102 described with reference to FIG. 1. The operations of the process 1000 and subject matter of the present disclosure may be applicable for different systems. For example, the operations of the process 1000 and the subject matter of the present disclosure may apply to 802.11s mesh system (as defined in Institute of Electrical and Electronics Engineers (IEEE) 802.11), an easy mesh system (as defined in WiFi Alliance), and/or other mesh-based network systems.

At 1010, the process 1000 includes the first wireless node obtaining information that indicates at least one of (i) one or more criteria that, when met by the second wireless node, indicate the second wireless node is allowed to request that the first wireless node modify one or more wireless operating parameters, or (ii) one or more options for modifying the wireless operating parameters of the first wireless node.

At 1020, the process 1000 includes the first wireless node outputting, for transmission, a first request that requests the first wireless node to modify the wireless operating capability based on the information.

In some aspects, the method 1000 further includes obtaining additional information that indicates an update to at least one of: the criteria or the options.

In some aspects, the method 1000 further includes outputting, for transmission, a second request that requests the first wireless node to modify the wireless operating capability based on the additional information.

In some aspects, the operating parameters comprise at least one of: bandwidth, a number of spatial streams, transmit power, or a resource unit (RU) size.

In some aspects, the options include one or more options to increase or decrease a quantity of active primary channels or a quantity of active links.

In some aspects, at least one of the wireless operating parameters is associated with an operating mode.

In some aspects, at least one of the one or more criteria depend on at least one of: an amount of traffic that the second wireless node has to send or has sent, a type of traffic that the second wireless node has to send or has sent, a type of the second wireless node, a capability of the second wireless node, a battery state of the second wireless node, or a number of requests that the second wireless node has sent in a period of time, in accordance with the criteria.

In some aspects, the criteria include different criteria corresponding to different options for modifying the wireless operating parameters.

In some aspects, the information further indicates at least one of: a type of a frame to use for signaling the first request for the first wireless node to modify the wireless operating capability, whether the frame should be protected, a type of protection for the frame, or whether the frame should be individually addressed or group addressed.

In some aspects, a modification of the wireless operating capability indicated in the first request will be valid for at least one duration; and the at least one duration is at least one of: indicated in the information, indicated in the first request, negotiated with the second wireless node, or periodic.

In some aspects, the method 1000 further includes at least one of: protecting the first request via at least one of encryption or a message integrity check (MIC).

In some aspects, the method 1000 further includes obtaining a response to the first request.

In some aspects, the method 1000 further includes decrypting content of the response to the first request.

In some aspects, the method 1000 further includes or validating the content of the response to the first request via a MIC.

In some aspects, the method 1000 further includes obtaining a response to the first request, wherein the response indicates at least one of: whether the first request is granted or denied, a reason if the first request is denied, or additional information not previously indicated in the information.

In some aspects, the additional information indicates at least one of: one or more wireless nodes to which the modification indicated in the first request applies, or one or more actions for the second wireless node to perform, and the method further comprises at least one of: generating a second request based on the additional information; or performing the one or more actions.

In one aspect, method 1000, or any aspect related to it, may be performed by an apparatus, such as wireless communication device 1100 of FIG. 11, which includes various components operable, configured, or adapted to perform the method 1000. Communications device 1100 is described below in further detail.

Note that FIG. 10 is just one example of a method, and other methods including fewer, additional, or alternative steps are possible consistent with this disclosure.

FIG. 11 shows a block diagram of a wireless communication device 1100 (such as an AP or non-AP STA), according to some aspects of the present disclosure. In one example, the wireless communication device 1100 is configured or operable to perform a process 900 described with reference to FIG. 9. In another example, the wireless communication device 1100 is configured or operable to perform a process 1100 described with reference to FIG. 10. In various examples, the wireless communication device 1100 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some examples, the wireless communication device 1100 can be a device for use in an AP, such as AP 102 described with reference to FIG. 1. In some other examples, the wireless communication device 1100 can be an AP that includes a chip, SoC, chipset, package or device as well as multiple antennas. The wireless communication device 1100 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1100 also includes or can be coupled with an application processor which may be further coupled with another memory. In some examples, the wireless communication device 1100 further includes at least one external network interface that enables communication with a core network or backhaul network to gain access to external networks including the Internet.

The wireless communication device 1100 includes obtaining component 1102, outputting component 1104, encrypting component 1106, processing component 1108, selecting component 1110, performing component 1112, decrypting component 1114, validating component 1116, protecting component 1118, decreasing component 1120, rejecting component 1122, reducing component 1124, disassociating component 1126, increasing component 1128, and/or generating component 1130.

Portions of one or more of the components 1102, 1104, 1106, 1108, 1110, 1112, 1114, 1116, 1118, 1120, 1122, 1124, 1126, 1128, and/or 1130 may be implemented at least in part in hardware or firmware. For example, the obtaining component 1102 and the outputting component 1104 may be implemented at least in part by a modem. In some examples, at least some of the components 1102, 1104, 1106, 1108, 1110, 1112, 1114, 1116, 1118, 1120, 1122, 1124, 1126, 1128, and/or 1130 are implemented at least in part by a processor and as software stored in a memory. For example, portions of one or more of the components 1102, 1104, 1106, 1108, 1110, 1112, 1114, 1116, 1118, 1120, 1122, 1124, 1126, 1128, and/or 1130 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the wireless communication device 1100). For example, a processing system of the wireless communication device 1100 may refer to a system including the various other components or subcomponents of the wireless communication device 1100, such as the processor, or a transceiver, or a communications manager, or other components or combinations of components of the wireless communication device 1100. The processing system of the wireless communication device 1100 may interface with other components of the wireless communication device 1100, and may process information received from other components (such as inputs or signals) or output information to other components. For example, a chip or modem of the wireless communication device 1100 may include a processing system, a first interface to output information and a second interface to obtain information. In some implementations, the first interface may refer to an interface between the processing system of the chip or modem and a transmitter, such that the wireless communication device 1100 may transmit information output from the chip or modem. In some implementations, the second interface may refer to an interface between the processing system of the chip or modem and a receiver, such that the wireless communication device 1100 may obtain information or signal inputs, and the information may be passed to the processing system. A person having ordinary skill in the art will readily recognize that the first interface also may obtain information or signal inputs, and the second interface also may output information or signal outputs.

The obtaining component 1102 may be capable of, configured to, or operable to at least obtain a first request that requests the first wireless node to modify the wireless operating parameters.

The outputting component 1104 may be capable of, configured to, or operable to at least output, for transmission, information that indicates at least one of (i) one or more criteria that, when met by a second wireless node, indicate the second wireless node is allowed to request that the first wireless node modify one or more wireless operating parameters, or (ii) one or more options for modifying the wireless operating parameters of the first wireless node.

The encrypting component 1106 may be capable of, configured to, or operable to at least encrypt content of the response to the first request.

The processing component 1108 may be capable of, configured to, or operable to at least process the first request based on the information.

The selecting component 1110 may be capable of, configured to, or operable to at least select the one or more actions based on a previous action.

The performing component 1112 may be capable of, configured to, or operable to at least perform one or more actions if the second wireless node meets at least one of the criteria.

The decrypting component 1114 may be capable of, configured to, or operable to at least decrypt the first request.

The validating component 1116 may be capable of, configured to, or operable to at least validate the first request based on a message integrity check (MIC).

The protecting component 1118 may be capable of, configured to, or operable to at least protect the content of the response to the first request via a MIC.

The decreasing component 1120 may be capable of, configured to, or operable to at least decrease an amount of credit assigned to the second wireless node.

The rejecting component 1122 may be capable of, configured to, or operable to at least reject one or more requests from the second wireless node for a period of time.

The reducing component 1124 may be capable of, configured to, or operable to at least reduce how often the second wireless node is served by the first wireless node for a period of time.

The disassociating component 1126 may be capable of, configured to, or operable to at least disassociate the second wireless node from the first wireless node.

The increasing component 1128 may be capable of, configured to, or operable to at least increase an amount of credit assigned to the second wireless node.

The generating component 1130 may be capable of, configured to, or operable to at least generate a second request based on the additional information.

Various components of the wireless communication device 1100 may provide means for performing the process 900 described with reference to FIG. 9, the process 1000 described with reference to FIG. 10, or any aspect related to it. Means for receiving or obtaining may include transceivers and/or antenna(s) of the AP 102 described with reference to FIG. 1 and/or the obtaining component 1102 of the wireless communication device 1100. Means for transmitting, sending or outputting for transmission may include transceivers and/or antenna(s) of the AP 102 described with reference to FIG. 1 and/or the outputting component 1104 of the wireless communication device 1100.

Means for encrypting may include one or more processors (such as a receive processor, a controller, and/or a transmit processor) of the AP 102 described with reference to FIG. 1 and/or the encrypting component 1106 of the wireless communication device 1100. Means for processing may include one or more processors (such as a receive processor, a controller, and/or a transmit processor) of the AP 102 described with reference to FIG. 1 and/or the processing component 1108 of the wireless communication device 1100. Means for selecting may include one or more processors (such as a receive processor, a controller, and/or a transmit processor) of the AP 102 described with reference to FIG. 1 and/or the selecting component 1110 of the wireless communication device 1100. Means for performing may include one or more processors (such as a receive processor, a controller, and/or a transmit processor) of the AP 102 described with reference to FIG. 1 and/or the performing component 1112 of the wireless communication device 1100. Means for decrypting may include one or more processors (such as a receive processor, a controller, and/or a transmit processor) of the AP 102 described with reference to FIG. 1 and/or the decrypting component 1114 of the wireless communication device 1100. Means for validating may include one or more processors (such as a receive processor, a controller, and/or a transmit processor) of the AP 102 described with reference to FIG. 1 and/or the validating component 1116 of the wireless communication device 1100. Means for protecting may include one or more processors (such as a receive processor, a controller, and/or a transmit processor) of the AP 102 described with reference to FIG. 1 and/or the protecting component 1118 of the wireless communication device 1100. Means for decreasing may include one or more processors (such as a receive processor, a controller, and/or a transmit processor) of the AP 102 described with reference to FIG. 1 and/or the decreasing component 1120 of the wireless communication device 1100. Means for rejecting may include one or more processors (such as a receive processor, a controller, and/or a transmit processor) of the AP 102 described with reference to FIG. 1 and/or the rejecting component 1122 of the wireless communication device 1100. Means for reducing may include one or more processors (such as a receive processor, a controller, and/or a transmit processor) of the AP 102 described with reference to FIG. 1 and/or the reducing component 1124 of the wireless communication device 1100. Means for disassociating may include one or more processors (such as a receive processor, a controller, and/or a transmit processor) of the AP 102 described with reference to FIG. 1 and/or the disassociating component 1126 of the wireless communication device 1100. Means for increasing may include one or more processors (such as a receive processor, a controller, and/or a transmit processor) of the AP 102 described with reference to FIG. 1 and/or the increasing component 1128 of the wireless communication device 1100. Means for generating may include one or more processors (such as a receive processor, a controller, and/or a transmit processor) of the AP 102 described with reference to FIG. 1 and/or the generating component 1130 of the wireless communication device 1100.

In some cases, rather than actually transmitting, for example, signals and/or data, the wireless communication device 1100 may have an interface to output signals and/or data for transmission (means for outputting). For example, a processor may output signals and/or data, via a bus interface, to a radio frequency (RF) front end of the wireless communication device 1100 for transmission. In various aspects, the RF front end may include various components, including transmit and receive processors, transmit and receive MIMO processors, modulators, demodulators, and the like.

In some cases, rather than actually receiving signals and/or data, the wireless communication device 1100 may have an interface to obtain the signals and/or data received from another device (means for obtaining). For example, a processor may obtain (or receive) the signals and/or data, via a bus interface, from an RF front end of the wireless communication device 1100 for reception. In various aspects, the RF front end may include various components, including transmit and receive processors, transmit and receive MIMO processors, modulators, demodulators, and the like.

### Example Clauses

Implementation examples are described in the following numbered clauses:

Clause 1: A method for wireless communications at a first wireless node, comprising: outputting, for transmission, information that indicates at least one of (i) one or more criteria that, when met by a second wireless node, indicate the second wireless node is allowed to request that the first wireless node modify one or more wireless operating parameters, or (ii) one or more options for modifying the wireless operating parameters of the first wireless node; obtaining a first request that requests the first wireless node to modify the wireless operating parameters; and processing the first request based on the information.

Clause 2: The method of Clause 1, further comprising: outputting, for transmission, additional information that indicates an update to at least one of: the criteria or the options.

Clause 3: The method of any one of Clauses 1-2, wherein the operating parameters comprise at least one of: bandwidth, a number of spatial streams, transmit power, or a resource unit (RU) size.

Clause 4: The method of any one of Clauses 1-3, wherein the options include one or more options to increase or decrease a quantity of active primary channels or a quantity of active links.

Clause 5: The method of any one of Clauses 1-4, wherein at least one of wireless operating parameters is associated with an operating mode.

Clause 6: The method of any one of Clauses 1-5, wherein at least one of the one or more criteria depend on at least one of: an amount of traffic that the second wireless node has to send or has sent, a type of traffic that the second wireless node has to send or has sent, a type of the second wireless node, a capability of the second wireless node, a battery state of the second wireless node, or a number of requests that the second wireless node has sent in a period of time.

Clause 7: The method of any one of Clauses 1-6, wherein the criteria include different criteria corresponding to different options for modifying the wireless operating parameters.

Clause 8: The method of any one of Clauses 1-7, wherein processing the request comprises: performing one or more actions if the second wireless node does not meet at least one of the criteria.

Clause 9: The method of Clause 8, wherein the one or more actions comprise at least one of: decreasing an amount of credit assigned to the second wireless node; rejecting one or more requests from the second wireless node for a period of time; reducing how often the second wireless node is served by the first wireless node for a period of time; or disassociating the second wireless node from the first wireless node.

Clause 10: The method of Clause 8, further comprising: selecting the one or more actions based on a previous action.

Clause 11: The method of any one of Clauses 1-10, further comprising:
performing one or more actions if the second wireless node meets at least one of the criteria.

Clause 12: The method of Clause 11, wherein the one or more actions comprise at least one of: increasing an amount of credit assigned to the second wireless node; or increasing how often the second wireless node is served by the first wireless node.

Clause 13: The method of any one of Clauses 1-12, wherein the information further indicates at least one of: a type of a frame to use for signaling the first request for the first wireless node to modify the wireless operating capability, whether the frame should be protected, a type of protection for the frame, or whether the frame should be individually addressed or group addressed.

Clause 14: The method of any one of Clauses 1-13, wherein: a modification of the wireless operating capability indicated in the first request will be valid for at least one duration; and the at least one duration is at least one of: indicated in the information, indicated in the first request, negotiated with the second wireless node, or periodic.

Clause 15: The method of any one of Clauses 1-14, further comprising: at least one of: decrypting the first request; validating the first request based on a message integrity check (MIC); outputting, for transmission, a response to the first request; encrypting content of the response to the first request; and or protecting the content of the response to the first request via a MIC.

Clause 16: The method of any one of Clauses 1-15, further comprising:
outputting, for transmission, a response to the first request, wherein the response indicates at least one of: whether the first request is granted or denied, a reason if the first request is denied, or additional information not previously indicated in the information.

Clause 17: The method of Clause 16, wherein the additional information indicates at least one of: one or more wireless nodes to which the modification indicated in the first request applies, or one or more actions for the second wireless node to perform.

Clause 18: A method for wireless communications at a second wireless node, comprising: obtaining information that indicates at least one of (i) one or more criteria that, when met by the second wireless node, indicate the second wireless node is allowed to request a first wireless node to modify one or more wireless operating parameters, or (ii) one or more options for modifying the one or more wireless operating parameters of the first wireless node; and outputting, for transmission, a first request that requests the first wireless node to modify the wireless operating parameters based on the information.

Clause 19: The method of Clause 18, further comprising: obtaining additional information that indicates an update to at least one of: the criteria or the options; and outputting, for transmission, a second request that requests the first wireless node to modify the wireless operating capability based on the additional information.

Clause 20: The method of any one of Clauses 18-19, wherein the operating parameters comprise at least one of: bandwidth, a number of spatial streams, transmit power, or a resource unit (RU) size.

Clause 21: The method of any one of Clauses 18-20, wherein the options include one or more options to increase or decrease a quantity of active primary channels or a quantity of active links.

Clause 22: The method of any one of Clauses 18-21, wherein at least one of the wireless operating parameters is associated with an operating mode.

Clause 23: The method of any one of Clauses 18-22, wherein at least one of the one or more criteria depend on at least one of: an amount of traffic that the second wireless node has to send or has sent, a type of traffic that the second wireless node has to send or has sent, a type of the second wireless node, a capability of the second wireless node, a battery state of the second wireless node, or a number of requests that the second wireless node has sent in a period of time, in accordance with the criteria.

Clause 24: The method of any one of Clauses 18-23, wherein the criteria include different criteria corresponding to different options for modifying the wireless operating parameters.

Clause 25: The method of any one of Clauses 18-24, wherein the information further indicates at least one of: a type of a frame to use for signaling the first request for the first wireless node to modify the wireless operating capability, whether the frame should be protected, a type of protection for the frame, or whether the frame should be individually addressed or group addressed.

Clause 26: The method of any one of Clauses 18-25, wherein: a modification of the wireless operating capability indicated in the first request will be valid for at least one duration; and the at least one duration is at least one of: indicated in the information, indicated in the first request, negotiated with the second wireless node, or periodic.

Clause 27: The method of any one of Clauses 18-26, further comprising: at least one of: protecting the first request via at least one of encryption or a message integrity check (MIC); obtaining a response to the first request; decrypting content of the response to the first request; and or validating the content of the response to the first request via a MIC.

Clause 28: The method of any one of Clauses 18-27, further comprising:
obtaining a response to the first request, wherein the response indicates at least one of: whether the first request is granted or denied, a reason if the first request is denied, or additional information not previously indicated in the information.

Clause 29: The method of Clause 28, wherein: the additional information indicates at least one of: one or more wireless nodes to which the modification indicated in the first request applies, or one or more actions for the second wireless node to perform, and the method further comprises at least one of: generating a second request based on the additional information; or performing the one or more actions.

Clause 30: An apparatus, comprising: a memory comprising executable instructions; and a processor configured to execute the executable instructions and cause the apparatus to perform a method in accordance with any one of Clauses 1-29.

Clause 31: An apparatus, comprising means for performing a method in accordance with any one of Clauses 1-29.

Clause 32: A non-transitory computer-readable medium comprising executable instructions that, when executed by a processor of an apparatus, cause the apparatus to perform a method in accordance with any one of Clauses 1-29.

Clause 33: A computer program product embodied on a computer-readable storage medium comprising code for performing a method in accordance with any one of Clauses 1-29.

Clause 34: An access point comprising: at least one transceiver, a memory comprising executable instructions; and a processor configured to execute the executable instructions and cause the UE to perform a method in accordance with any one of Clauses 1-17, wherein the at least one transceiver is configured to at least one of transmit the information or receive the first request.

Clause 35: A wireless station comprising: at least one transceiver, a memory comprising executable instructions; and a processor configured to execute the executable instructions and cause the UE to perform a method in accordance with any one of Clauses 18-29, wherein the at least one transceiver is configured to at least one of receive the information or transmit the first request.

### ADDITIONAL CONSIDERATIONS

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communications at a first wireless node, comprising:
a processor;
memory coupled with the processor; and
instructions stored in the memory and executable by the processor to cause the apparatus to:
output, for transmission, information that indicates at least one of (i) one or more criteria that, when met by a second wireless node, indicate the second wireless node is allowed to request that the first wireless node modify one or more wireless operating parameters, or (ii) one or more options for modifying the wireless operating parameters of the first wireless node;
obtain a first request that requests the first wireless node to modify the wireless operating parameters; and
process the first request based on the information.

2. The apparatus of claim 1, wherein the instructions stored in the memory and executable by the processor further cause the apparatus to output, for transmission, additional information that indicates an update to at least one of: the criteria or the options.

3. The apparatus of claim 1, wherein the wireless operating parameters comprise at least one of: bandwidth, a number of spatial streams, transmit power, or a resource unit (RU) size.

4. The apparatus of claim 1, wherein the options include one or more options to increase or decrease a quantity of active primary channels or a quantity of active links.

5. The apparatus of claim 1, wherein at least one of wireless operating parameters is associated with an operating mode.

6. The apparatus of claim 1, wherein at least one of the one or more criteria depend on at least one of:
an amount of traffic that the second wireless node has to send or has sent,
a type of traffic that the second wireless node has to send or has sent,
a type of the second wireless node,
a capability of the second wireless node,
a battery state of the second wireless node, or
a number of requests that the second wireless node has sent in a period of time.

7. The apparatus of claim 1, wherein the criteria include different criteria corresponding to different options for modifying the wireless operating parameters.

8. The apparatus of claim 1, wherein processing the first request comprises:
performing one or more actions if the second wireless node does not meet at least one of the criteria.

9. The apparatus of claim 8, wherein the one or more actions comprise at least one of:
decreasing an amount of credit assigned to the second wireless node;
rejecting one or more requests from the second wireless node for a period of time;
reducing how often the second wireless node is served by the first wireless node for a period of time; or
disassociating the second wireless node from the first wireless node.

10. The apparatus of claim 8, wherein the instructions stored in the memory and executable by the processor further cause the apparatus to select the one or more actions based on a previous action.

11. The apparatus of claim 1, wherein the instructions stored in the memory and executable by the processor further cause the apparatus to:
perform one or more actions if the second wireless node meets at least one of the criteria, wherein the one or more actions comprise at least one of:
increasing an amount of credit assigned to the second wireless node; or
increasing how often the second wireless node is served by the first wireless node.

12. The apparatus of claim 1, wherein the information further indicates at least one of:
a type of a frame to use for signaling the first request for the first wireless node to modify the wireless operating parameters,
whether the frame should be protected,
a type of protection for the frame, or
whether the frame should be individually addressed or group addressed.

13. The apparatus of claim 1, wherein:
a modification of the wireless operating parameters indicated in the first request will be valid for at least one duration; and
the at least one duration is at least one of:
indicated in the information,
indicated in the first request,
negotiated with the second wireless node, or
periodic.

14. The apparatus of claim 1, wherein the instructions stored in the memory and executable by the processor further cause the apparatus to at least one of:
decrypt the first request;
validate the first request based on a message integrity check (MIC);
output, for transmission, a response to the first request;
encrypt content of the response to the first request; or
protect the content of the response to the first request via a MIC.

15. The apparatus of claim 1, wherein the instructions stored in the memory and executable by the processor further cause the apparatus to:
output, for transmission, a response to the first request, wherein the response indicates at least one of:
whether the first request is granted or denied,
a reason if the first request is denied, or
additional information not previously indicated in the information.

16. The apparatus of claim 15, wherein the additional information indicates at least one of:
one or more wireless nodes to which the modification indicated in the first request applies, or
one or more actions for the second wireless node to perform.

17. The apparatus of claim 1, further comprising:
at least one transceiver configured to transmit the information or receive the first request, wherein the apparatus is configured as an access point (AP).

18. An apparatus for wireless communications at a second wireless node, comprising:
a processor;
memory coupled with the processor; and
instructions stored in the memory and executable by the processor to cause the apparatus to:
obtain information that indicates at least one of (i) one or more criteria that, when met by the second wireless node, indicate the second wireless node is allowed to request a first wireless node to modify one or more wireless operating parameters, or (ii) one or more options for modifying the one or more wireless operating parameters of the first wireless node; and
output, for transmission, a first request that requests the first wireless node to modify the wireless operating parameters based on the information.

19. The apparatus of claim 18, wherein the instructions stored in the memory and executable by the processor further cause the apparatus to:
obtain additional information that indicates an update to at least one of: the criteria or the options; and
output, for transmission, a second request that requests the first wireless node to modify the wireless operating parameters based on the additional information.

20. The apparatus of claim 18, wherein the wireless operating parameters comprise at least one of: bandwidth, a number of spatial streams, transmit power, or a resource unit (RU) size.

21. The apparatus of claim 18, wherein the options include one or more options to increase or decrease a quantity of active primary channels or a quantity of active links.

22. The apparatus of claim 18, wherein:
at least one of the wireless operating parameters is associated with an operating mode, and
the criteria include different criteria corresponding to different options for modifying the wireless operating parameters.

23. The apparatus of claim 18, wherein at least one of the one or more criteria depend on at least one of:
an amount of traffic that the second wireless node has to send or has sent,
a type of traffic that the second wireless node has to send or has sent,
a type of the second wireless node,
a capability of the second wireless node,
a battery state of the second wireless node, or
a number of requests that the second wireless node has sent in a period of time, in accordance with the criteria.

24. The apparatus of claim 18, wherein the information further indicates at least one of:
a type of a frame to use for signaling the first request for the first wireless node to modify the wireless operating parameters,
whether the frame should be protected,
a type of protection for the frame, or
whether the frame should be individually addressed or group addressed.

25. The apparatus of claim 18, wherein:
a modification of the wireless operating parameters indicated in the first request will be valid for at least one duration; and
the at least one duration is at least one of:
indicated in the information,
indicated in the first request,
negotiated with the second wireless node, or
periodic.

26. The apparatus of claim 18, wherein the instructions stored in the memory and executable by the processor further cause the apparatus to at least one of:
protect the first request via at least one of encryption or a message integrity check (MIC);
obtain a response to the first request;
decrypt content of the response to the first request; or
validate the content of the response to the first request via a MIC.

27. The apparatus of claim 18, wherein the instructions stored in the memory and executable by the processor further cause the apparatus to obtain a response to the first request, wherein the response indicates at least one of:
whether the first request is granted or denied,
a reason if the first request is denied, or
additional information not previously indicated in the information.

28. The apparatus of claim 27, wherein:
the additional information indicates at least one of: one or more wireless nodes to which the modification indicated in the first request applies, or one or more actions for the second wireless node to perform, and
the instructions stored in the memory and executable by the processor further cause the apparatus to at least one of:
generate a second request based on the additional information; or
perform the one or more actions.

29. The apparatus of claim 18, further comprising:
at least one transceiver configured to receive the information or transmit the first request, wherein the apparatus is configured as a wireless station.

30. A method for wireless communications at a first wireless node, comprising:
outputting, for transmission, information that indicates at least one of (i) one or more criteria that, when met by a second wireless node, indicate the second wireless node is allowed to request that the first wireless node modify one or more wireless operating parameters, or (ii) one or more options for modifying the wireless operating parameters of the first wireless node;
obtaining a first request that requests the first wireless node to modify the wireless operating parameters; and
processing the first request based on the information.
